(19) United States
(12) Patent Application Publication
(10) Pub. No.: US 2023/0401036 A1
(43) Pub. Date: Dec. 14, 2023

(54) METHODS AND SYSTEMS FOR QUANTUM COMPUTING

(71) Applicant: Texas Tech University System, Lubbock, TX (US)

(72) Inventor: Lionel W. Poirier, Lubbock, TX (US)

(21) Appl. No.: 17/979,623

(22) Filed: Nov. 2, 2022

Related U.S. Application Data
(60) Provisional application No. 63/274,877, filed on Nov. 2, 2021.

(51) Int. Cl. G06F 7/523; G06N 10/40

(52) U.S. Cl. CPC G06F 7/523; G06N 10/40

(57) ABSTRACT

A method and system for quantum exponentiation comprise a quantum circuit, the quantum circuit comprising a plurality of an integer number of d control qubits, an output register configured to store a current function value, at least one multiplication block, and an input register comprising a plurality of input qubits wherein successive multiplications are performed, according to the at least one multiplication block, between the current function value and successive constants stored in the input register, in order to evaluate a function.

### CROSS REFERENCE TO RELATED PATENT APPLICATIONS

This application claims the priority and benefit under 35 U.S.C. § 119(e) of U.S. Provisional Patent Application Ser. No. 63/274,877 filed Nov. 2, 2021, entitled “METHODS AND SYSTEMS FOR QUANTUM COMPUTING.” U.S. Provisional Patent Application Ser. No. 63/274,877 is herein incorporated by reference in its entirety.

### TECHNICAL FIELD

Embodiments are generally related to the field of quantum computers. Embodiments are further related to the field of computational modeling. Embodiments are also related to the field of quantum computations. Embodiments are further related to quantum computation circuits for exponential and Gaussian functions.

### BACKGROUND

Quantum computing represents the most promising frontier for a wide range of computational problems that even the most advanced “classical” computers cannot solve. Many industry leaders are investing heavily in quantum computing. One of the challenges associated with quantum computing is that coding for a quantum computer is very difficult and generally, not well understood.

The exponential and Gaussian functions are among the most fundamental and important computing operations, appearing ubiquitously throughout all areas of science, engineering, and mathematics. Whereas formally, it is well-known that any function may in principle be realized on a quantum computer, in practice present-day quantum solutions tend to be very numerically expensive.

For example, one of the best strategies for evaluating general functions, f(x), involves dividing the domain, x, into a collection of non-intersecting subdomains. The function can then be approximated using a separate d'th order polynomial for each subdomain. The above parallel strategy is general, conceptually elegant, and effective. However, in the words of those who developed the technique: “While these methods allow to reduce the Toffoli [gate] and qubit counts significantly, the resulting circuits are still quite expensive, especially in terms of the number of gates that are required.”

As such, there is a need in the art for a more efficient quantum based evaluation of functions, such as the exponential or gaussian function, as disclosed herein.

### SUMMARY

In one embodiment, the systems and methods disclosed herein are directed to new systems and processes for quantum evaluation. In certain embodiments, systems, and methods for evaluating exponential and Gaussian functions efficiently on quantum computers are disclosed. The implementations require a (generally) small number of multiplications, which represent the overall computational bottleneck. The disclosed embodiments are, in principle, equally applicable to noisy intermediate-scale quantum (NISQ) calculations with non-error-corrected quantum multiplications, as well as fault-tolerant calculations using error-corrected multiplications.

For example, in an embodiment, quantum logic is presented, which is designed specifically to evaluate exponential and Gaussian functions efficiently on quantum computers. These methods require a (generally) small number of multiplications. The disclosed embodiments are thus, in principle, equally applicable to NISQ calculations with non-error-corrected quantum multiplications, as well as fault-tolerant calculations using error-corrected multiplications. In all such contexts, the “total multiplication count” can be used as the appropriate gate complexity metric—although the “Toffoli count” metric, which is currently quite popular, is also of note.

The gate complexity for the disclosed embodiments is dramatically reduced as compared to other state-of-the art methods. Indeed, for a specific, realistic quantum computational chemistry (QCC) application, the Toffoli count of the exponential function is reduced from 15,690 down to 912, under the most favorable conditions for each method. For the corresponding Gaussian function comparison, the Toffoli count is reduced from 19,090 down to 704. Space requirements are also generally reduced, and by most measures, quite modest—to the extent that in one case, the above QCC application can be implemented with as few as approximately 20 logical qubits.

Although the disclosed embodiments can be applied to any applications where exponential and Gaussian functions are relevant, QCC—i.e., quantum chemistry on quantum computers is one noteworthy field of applicability (as is quantum finance). QCC has long been regarded as one of the first important scientific applications where quantum supremacy will likely be realized. Particularly for “first-quantized” or coordinate-grid-based QCC, it becomes necessary to evaluate functions over a (generally) uniformly-distributed set of discrete grid points exactly of the sort that emerges in fixed-point arithmetic, as used here.

The most natural function to arise in the QCC context is the inverse-square-root function, f(x)=x^{-1/2}, which can be used to represent Coulombic interactions. Even for a “general function evaluator” quantum code, this specific case poses some special challenges associated with the singularity at x=0, that result in substantially increased computational expense. On the other hand, the alternative Cartesian-component separated (CCS) approach, replaces the inverse square root with a small set of Gaussians. Using the disclosed exponential/Gaussian evaluator, the CCS approach becomes a viable approach to first-quantized QCC.

As such, the disclosed embodiments, include basic quantum exponentiation techniques and evaluator circuits, and associated asymptotic scaling. In certain embodiments, a detailed explanation of various computational improvements leading to reduced gate and space complexity are disclosed, that will be of particular value for quantum computing. In particular, quantum circuits for two specific implementations are presented—one designed to minimize gate complexity, and the other, space complexity.

In an embodiment a system comprises a quantum circuit, the quantum circuit comprising: a plurality of an integer number of d control qubits, an output register configured to store a current function value, at least one multiplication block, and an input register comprising a plurality of input qubits wherein successive multiplications are performed, according to the at least one multiplication block, between the current function value and successive constants stored in the input register, in order to evaluate a function. In an embodiment, the output register further comprises: a plurality of an integer number n of qubits configured to store the current function value. In an embodiment, the function comprises an exponential function. In an embodiment, the plurality of control qubits serve as control for the multiplication at the multiplication block. In an embodiment, each successive constant is stored in an integer n number of input qubits in the input register. In an embodiment, the at least one multiplication block comprises an integer number of d multiplication blocks. In an embodiment, the system further comprises at least one transformation gate configured to transform each of the successive constants into the next successive constant before the next multiplication block. In an embodiment the system further comprises a current function value transformation gate used to initialize the current function value. In an embodiment, the system further comprises a quantum computer, an input module for entering function parameters, quantum storage, and an output module for outputting the evaluated function.

In another embodiment, a method for quantum exponentiation, comprises representing the value of a function with a plurality of qubits, initially assigning an output register a constant value, storing a plurality of exponent values in a plurality of n qubits, multiplying the initially assigned constant value with a first of the plurality of exponent values to reach an adjusted constant value, iterating the multiplication for each of the exponent values with the adjusted constant value, and storing all of the adjusted constant values in an output register representing the value of the function. In an embodiment, the method for quantum exponentiation further comprises controlling the multiplication with a control qubit. In an embodiment, of the method for quantum exponentiation the function comprises an exponential function. In an embodiment, the method comprises defining a domain with a domain interval as xₘᵢₙ′≤x′≤xₘₐₓ′. In an embodiment, the domain is represented with a plurality of d qubits. In an embodiment, the multiplication for each of the exponent values is overwritten on an additional input register with the product of the multiplication of the exponent value and adjusted constant value.

In another embodiment, a non-overwriting quantum circuit comprises a first input register for storing a multiplier, a second input register for storing a multiplicand, an accumulator register, a plurality of cascading controlled addition blocks for summing inputs provided by the second input register and successively bit-shifted subsets of qubits from the accumulator register, a plurality of CNOT gates, and a domain qubit. In an embodiment, the accumulator register is initialized to zero and the accumulator register stores the product of the multiplier and multiplicand. In an embodiment, of the non-overwriting quantum circuit the controlled addition blocks use fixed-point arithmetic. In an embodiment, the non-overwriting quantum circuit of claim 16 further comprises a cascade of controlled bit-copy operations configured to set a final output of the accumulator register.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 illustrates a computer software system for directing the operation of the data-processing system depicted in FIG. 1, in accordance with an example embodiment;

FIG. 4 illustrates a quantum computer system, in accordance with the disclosed embodiments;

FIG. 5 illustrates a quantum circuit for exponentiation, in accordance with the disclosed embodiments;

FIG. 6 illustrates a first section of a quantum circuit for exponentiation, designed to minimize both space and gate complexity, in accordance with the disclosed embodiments;

FIG. 7 illustrates a quantum circuit for converting the constant A₀ into the constant A₁, in accordance with the disclosed embodiments;

FIG. 8 illustrates a second section of a quantum circuit for exponentiation, designed to minimize both space and gate complexity, in accordance with the disclosed embodiments;

FIG. 9 illustrates a quantum circuit used to implement reversible OR gates, in accordance with the disclosed embodiments;

FIG. 10 illustrates a quantum circuit for controlled multiplication on a quantum computer, in accordance with the disclosed embodiments; and

FIG. 11 illustrates another embodiment of a quantum circuit for exponentiation, assuming non-overwriting multiplications, designed to minimize space complexity, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

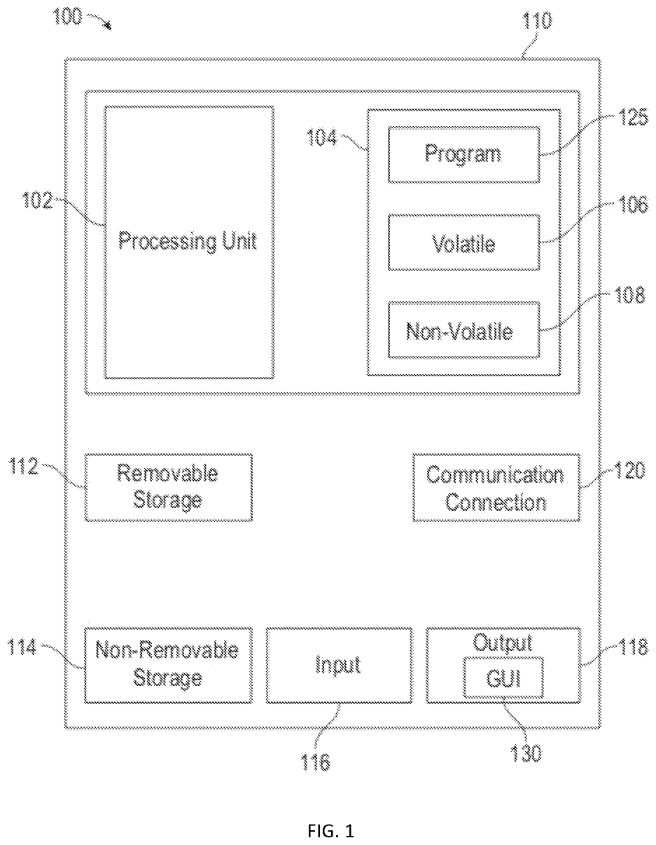

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with controllers, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

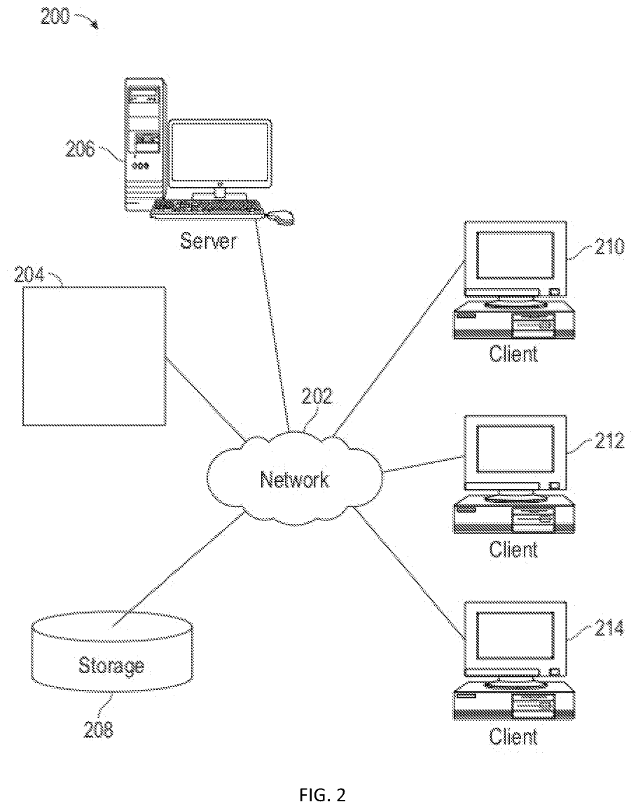

Computer 110 may include, or have access to, a computing environment that includes input 116, output 118, and a communication connection 120. The computer may operate in a networked environment using a communication connection 120 to connect to one or more remote computers, remote sensors and/or controllers, detection devices, hand-held devices, multi-function devices (MFDs), speakers, mobile devices, tablet devices, mobile phones, Smartphone, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse, and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 can be a network of computers or other such devices, such as mobile phones, smart phones, sensors, controllers, speakers, tactile devices, and the like, in which embodiments of the present invention may be implemented. Note that the system 200 can be implemented in the context of a software module such as program module 125. The system 200 includes a network 202 in communication with one or more clients 210, 212, and 214. Network 202 may also be in communication with one or more devices 204, servers 206, and storage 208. Network 202 is a medium that can be used to provide communications links between various devices and computers connected together within a networked data processing system such as computer system 100. Network 202 may include connections such as wired communication links, wireless communication links of various types, and fiber optic cables. Network 202 can communicate with one or more servers 206, one or more external devices such as device 204, and a memory storage unit such as, for example, memory or database 208. It should be understood that device 204 may be embodied as a quantum computer as disclosed herein.

In the depicted example, device 204, server 206, and clients 210, 212, and 214 connect to network 202 along with storage unit 208. Clients 210, 212, and 214 may be, for example, personal computers or network computers, handheld devices, mobile devices, tablet devices, smart phones, personal digital assistants, printing devices, recording devices, speakers, MFDs, etc. Computer system 100 depicted in FIG. 1 can be, for example, a client such as client 210 and/or 212 and/or 214.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet, with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

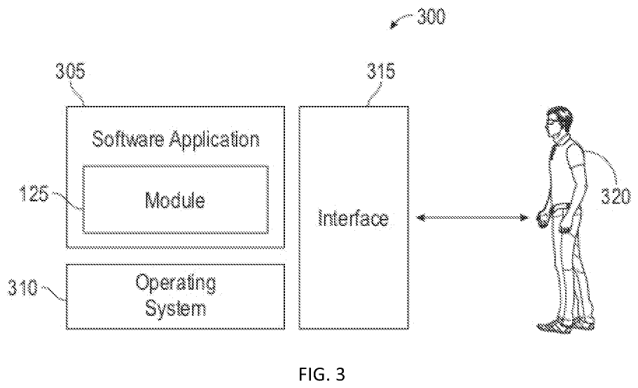

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, and the like.

Note that the term “module” or “node” as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real-time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of, a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the system and method of the present invention may be advantageously applied to a variety of systems and application software. Moreover, the present invention may be embodied on a variety of different platforms, including Windows, Macintosh, UNIX, LINUX, Android, Arduino, and the like on the classical computing side, using any number of standard programming languages and libraries (C++, Matlab, python, etc.). On the quantum computing side, the present invention may encompass any manner or combination of quantum hardware, quantum libraries, and quantum programming languages and scripts, including quantum libraries for standard classical computing languages, and languages, libraries, and hardware developed in conjunction with specific commercial platforms and various open-source efforts, such as, but not limited to: QSage, QMASM (D-Wave); Cirq, OpenFermion-Cirq (Google); QISKit, QASM (IBM); Q# (Microsoft); Forest, Grove, QAOA (Rigetti); Blackbird, Strawberry Fields (Xanadu); OpenFermion, ProjectQ (open source). Therefore, the descriptions of the exemplary embodiments, which follow, are for purposes of illustration and not considered a limitation.

In order to illustrate the disclosed systems and methods consider the exponential function of equation (1):

f(x′)=exp(−αx′) (1)

As an exemplary case, the systems and methods disclosed herein are configured to evaluate the function over the domain interval, xₘᵢₙ′≤x′≤xₘₐₓ′, using a quantum computer. Note that x′ and α are presumed to be real-valued. If a were pure imaginary, then equation (1) would be unitary, but that is not the case here. For purposes of explanation, and without loss of generality, we can restrict consideration to α>0. The negative α case corresponds to the above, but with x′→−x′, xₘᵢₙ′→−xₘₐₓ′, and xₘₐₓ′→−xₘᵢₙ′.

Both the domain and the range of equation (1) can be represented discretely, using a finite number of qubits. For generality, the number of domain qubits, d, is allowed to differ from the number of range qubits, n. In the first-quantized QCC context, for instance, the d<<n case arises very naturally (where ‘<<’ can represent a factor of 3 or 4). More specifically, something like 100 grid points are needed to accurately represent each domain degree of freedom, although the function values themselves require a precision of somewhere between, 6-10 digits. For purposes of explanation, the discussion herein focuses on the d<<n case, although the d=n special case is obviously also important, and will also be considered.

The d qubits used to represent the domain correspond to 2^{d} distinct grid points, distributed uniformly across the x′ interval, with grid spacing Δ=2^{-d}(xₘₐₓ′−xₘᵢₙ′). Such representations are typical in quantum arithmetic, and imply fixed-point rather than floating-point implementations. Indeed, since fixed-point arithmetic is closely related to integer arithmetic, it is convenient to transform x′ to the unitless domain variable, given by equation (2):

$$x = \frac{( {x}^{′} - {x}_{min}^{′} )}{Δ} \qquad ( 2 )$$

such that the x grid points become integers, x={0, 1, . . . , 2^{d}−1}. In terms of x, the function then can be represented as illustrated in equations (3) and (4) as:

f(x)=exp[−α(xₘᵢₙ′+Δx)]=CA^{x}, where (3)

C=exp(−αx′ₘᵢₙ) and A=exp(−αΔ) (4)

Next, the following binary decomposition of the x integers is defined, in terms of the d individual qubits, xᵢ, with 0≤i<d and xᵢ={0,1}, in equation (5) as:

x=Σᵢ₌₀^{d-1}xᵢ2ⁱ (5)

Note that increasing i corresponds to larger powers of 2; thus, the binary expansion of the integer x would be x_{d-1} . . . x₁ x₀. Put another way, the lowest index values correspond to the rightmost, or least significant, digits in the binary expansion. This convention is adopted throughout. Substituting equation (5) into equation (3), gives equations (6) and (7) as follows:

f(x)=C(A²^{⁰})^{x}^{₀}(A²^{¹})^{x}^{₁} . . . (A²^{^{d-1}})^{x}^{_{d-1}}=CA₀^{x}^{₀}A₁^{x}^{₁} . . . A_{d-1}^{x}^{_{d-1}}, where (6)

Aᵢ=A²^{ⁱ} (7)

In this manner, exponentiation is replaced with a sequence of d multiplications. Note from Eq. (7) that A₀=A. As additional notation, it is convenient to introduce the quantities C₀≤i≤d, through the recursion relation Cᵢ₊₁=Cᵢ Aᵢ^{xi} with C₀=C. Thus, C_{d}=f(x), and the other C_{i<d} quantities represent partial products in equation (6).

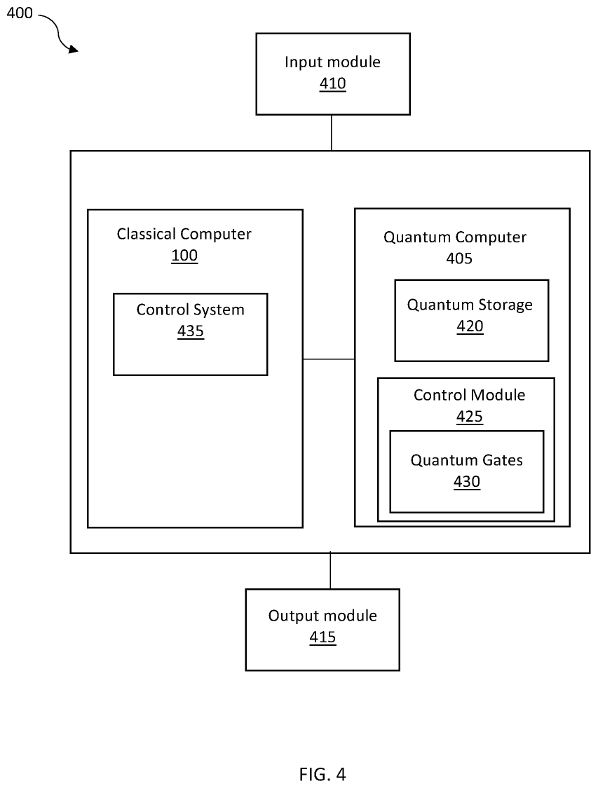

FIG. 4 depict exemplary systems 400 for quantum computer processing, using either one or both of a classical computer 100 or a quantum computer 405. The exemplary quantum system 400 is an example of a system implemented using classical and/or quantum computer programs on one or more classical computers 100 or quantum computing devices 405 in one or more locations, in which the systems, components, and techniques described below can be implemented.

In certain embodiments a quantum system 400 can include quantum hardware configured to interface with a classical computer such as computer system 100 as illustrated in FIG. 1. In certain embodiments, quantum computing can be performed with a quantum computer 405. In other embodiments, quantum computing, or certain control aspects thereof, can be performed on a classical computer 100. In other embodiments, aspects of the computation can be performed on the classical computer 100 and other aspects can be performed on the quantum computer 405.

The quantum system 400 can include an input module 410 for inputting data. The quantum system 400 can also include an output module 415 wherein data representing one or more quantum solutions (e.g., solutions to an exponential or gaussian function, ground and/or excited state energy levels, eigenstate and time-evolved wavefunctions, correlation functions, etc.) can be presented.

The quantum system 400 can be configured such that some operations are controlled with a classical computer control system 435, or can be configured to perform certain operations in combination with a quantum computer 405 using quantum hardware, and/or can be configured to perform operations with a quantum computer 405 using quantum software. The quantum hardware may include components for performing quantum computation. For example, the quantum hardware can include a quantum control and a quantum system. It should be appreciated that the quantum control and quantum system can be embodied as any number of known quantum computing systems without departing from the scope of this disclosure.

The quantum system 400 can include one or more multi-level quantum data storage 420. The multi-level quantum data storage structures 420 can be referred to as qubits. The type of quantum computer that the quantum system 400 uses can be selected from a variety of known quantum computing systems which can include one or more resonators attached to one or more superconducting qubits, e.g., Gmon or Xmon qubits. In other cases, ion traps, nuclear or electron spin, photonic devices, topological anyons, or superconducting cavities can be used. In other embodiments quantum subsystems include fluxmon qubits, silicon quantum dots or phosphorus impurity qubits. The quantum computer can include quantum circuits. The quantum computer 405 can include a control module or device 425 used to control quantum logic gates 430 associated with the quantum system.

The quantum hardware can further be selected according to the type of qubits included in the quantum computer 405. For example, in some cases the control devices can include devices that control the frequencies of qubits included in the quantum computer 405, e.g., an excitation pulse generator and control lines that couple the qubits to the excitation pulse generator. The control devices can then cause the frequency of each qubit to be adjusted towards or away from a quantum gate frequency of an excitation pulse on a corresponding control driveline. The control devices can also include measurement devices such as readout resonators. Measurement results obtained via measurement devices can be provided to the classical processors for processing and analyzing.

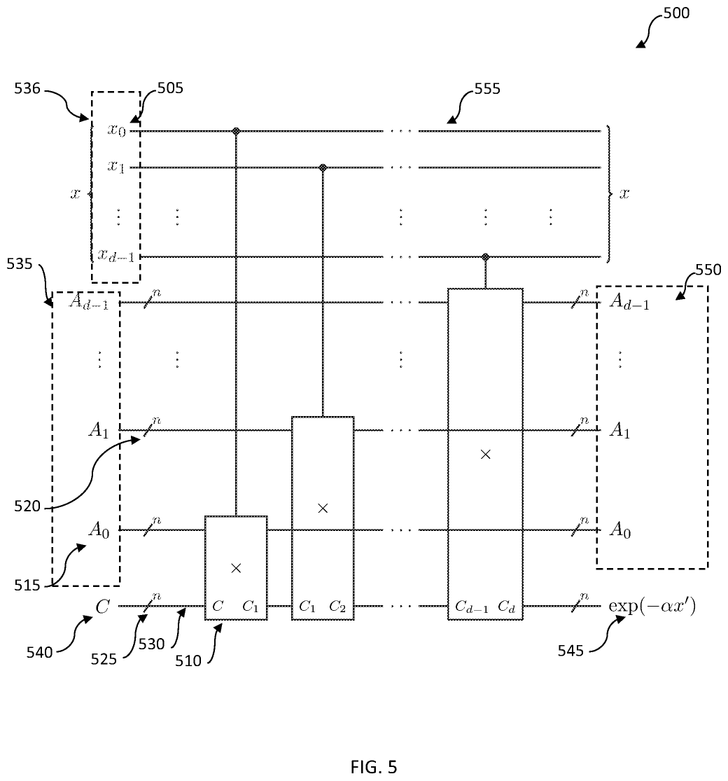

FIG. 5 illustrates a quantum circuit 500 used to implement exemplary basic quantum logic for exponentiation, f(x′)=exp(−αx′) in accordance with the disclosed embodiments. All multiplications, x, as illustrated in quantum circuit 500 are overwriting in the sense that the second input register is overwritten with the product of the two inputs as output.

The exponent of every Aᵢ value in equation (6) being the qubit xᵢ, is associated with the two states or values, 0 and 1. From a quantum computing perspective, therefore, this can be interpreted as an instruction: If xᵢ=1, then multiply by Aᵢ; otherwise, if xᵢ=0, do nothing.

This lends itself to a simple and straightforward quantum algorithm for exponentiation, comprising nothing but a sequence of d controlled multiplications, as illustrated in the quantum circuit 500 in FIG. 5. As illustrated, each of the d qubits, xᵢ, serves as the control qubit 505 for a separate target multiplication 510 of Cᵢ by Aᵢ 515, in order to generate the next Cᵢ₊₁. The horizontal lines 555 represent wires or the time domain traveling from left to right, and the rectangular blocks 510 represent multiplications. In this embodiment, each of the d constants 515 illustrated as, Aᵢ, is stored by a separate bundle of n qubits 520, initialized prior to the calculation. An additional bundle of n qubits 525 (lowest wire 530 in FIG. 5) is used to represent the value of the function. This output register 525 is initially assigned the constant value C 540, but through successive controlled multiplications 510 with Aᵢ 535 as described above, ends up taking on the final output 545 value, C_{d}=f(x)=exp(−αx′).

It is noteworthy that, as illustrated in FIG. 5, one of the two input registers 530 for each multiplication gets overwritten with the product value as output, and the other 520 is unaffected. There are indeed some multiplication schemes (e.g., those based on the Quantum Fourier Transform (QFT)) that behave in this manner. We call these “overwriting” multiplication routines. Other standard quantum multiplication methods (e.g., those based on bit-shifted controlled additions) do not have this property.

According to the disclosed embodiments, the Cᵢ values can be stored in the n-qubit output register 545 (register 530 on input), whereas the Aᵢ are stored in d separate n-qubit input registers 535 (or 550 on output). Since 0<Aᵢ<1 for all Aᵢ, it is convenient to represent these constants using the following n-bit binary expansion given in equation (8):

y=Σⱼ₌₀ⁿ⁻¹yⱼ2^{-(n-j)} (8)

Thus, the binary expansion of y becomes y=0.yₙ₋₁ . . . y₁ y₀ with the y₀ bit least significant. This representation has a resolution of 2⁻ⁿ. Likewise, 0<Cᵢ≤1 for all 0≤l≤d, provided xₘᵢₙ′≥0 (if not, there are simple remedies that can be applied, although these are not needed here). It is, therefore, convenient to adopt the equation (8) representation for the Ci as well as the A values. This outlines the basic quantum logic or quantum circuit 500 for evaluating the exponential function of equation (1).

It should be understood that in this embodiment registers 535 (or 550) are input registers for this entire circuit 500, and they are not overwritten. The same is true for the control qubits 536. In contrast, the input register 530 does get overwritten, and on output, becomes the result of the calculation 545.

For the Gaussian function, given by equation (9) as:

f(x′)=exp(−αx′²) (9)

The same quantum circuit is used, except that it is necessary to perform an additional multiplication, to obtain x² from x. There are some specialized quantum squaring algorithms, that shave a bit off of the cost of a generic multiplication. If d<<n however, this savings is not significant; the cost of the extra multiplication itself is much less than the others since it involves only d rather than n qubits.

In terms of memory (i.e., space) usage, the embodiment illustrated above requires dn+n+d qubits in all—not including the ancilla bits needed to actually implement the multiplications (as further detailed herein). As mentioned, the computational cost is simply that of applying d multiplications. Given the tremendous variety of quantum multiplication methods, and given that some will always be better than others in different circumstances—the number of required multiplications may serve as the appropriate gate complexity metric. As such, multiplications comprise the overall computational bottleneck. Likewise, the Toffoli count provides another implementation-independent metric—when comparing circuits whose bottleneck is the Toffoli gate.

If absolute costs are difficult to compare directly between different methods, then the next best thing to consider is asymptotic scaling. In the disclosed embodiments, this is realized in terms of the parameters n and d. For the basic disclosed exponentiation method, the scaling with respect to d is clearly linear—both for the space and gate complexity. As for the scaling with respect to n, this is determined by the multiplication method itself.

One quantum multiplication method for asymptotically large n in terms of scaling appears is the recursive Karatsuba scheme. The so called Gidney method requires O(n) space complexity, so that the overall scaling for our basic exponentiation algorithm would be O(nd). Likewise, the gate complexity for a single multiplication scales as O(n^{log}^{₂} ³), implying O(n^{log}^{₂} ³d) scaling for basic exponentiation. As mentioned, Gidney does not overtake even the simplest (i.e., “schoolbook”) multiplication method until n reaches a few thousand. It is therefore not useful for most practical quantum computing applications such as QCC and quantum finance.

In other embodiments detailed herein, more precise estimates will be provided for absolute costs—e.g., in terms of Toffoli counts-presuming multiplication methods that can be practically applied in a QCC context. In additional embodiments, improvements upon the basic exponentiation method are presented where a more efficient and refined approach is provided, and in additional embodiments two specific implementations suitable for QCC calculations, or other applications, are presented.

At this point it is worthwhile to compare the two cases, d=n and d<<n. If the exponentiation operation is itself part of a more complicated mathematical function network, with many nested inputs and outputs, then presumably a generic d=n code is desirable, with n sufficiently large to provide “machine precision”—i.e., n≥25 or so for single precision, or n≥50 for double precision. The O(n²) space complexity of the basic exponentiation quantum circuit and associated method likely places such calculations beyond the limits of quantum hardware in the near future.

On the other hand, there are situations where d<<n, and where n itself may be substantially reduced. For first quantized QCC, for example, it is estimated that d=7 and n=21 may suffice to achieve the so-called “chemical accuracy” benchmark. Such values place the present embodiments much closer to the NISQ regime, especially those embodiments taking advantage of the refined embodiments further disclosed herein.

For reference, the true cost of the d<<n Gaussian function evaluation, within the present basic scope of the systems and methods disclosed herein, the x² operation per se adds little to the direct cost, but does have the effect of squaring the size of the domain interval. Thus, if the full resolution of the domain is to be preserved, this requires 2d rather than d qubits—as well as a commensurate doubling of the gate complexity. On the other hand, this relative increase can often be largely mitigated by the improvements disclosed herein.

The basic system and method illustrated in FIG. 5, can be substantially improved with respect to both space and gate complexity, using the refinements described herein. For simplicity and by way of example only, the “QCC parameter values,” are d=7 and n=21. It should be appreciated that these values are exemplary and other values can be used in other embodiments. However, for comparison and robustness testing, the less spartan parameter values, d=8 and n=32 (corresponding to “machine precision”) are also used as example values.

There are two distinct aspects of the disclosed methods and systems used to improve upon the embodiment illustrated in FIG. 5, although other possible options also exist. The first aspect is to transform the constant Aᵢ values between successive multiplications, so that only one such constant need be stored at a time. This will have the effect of reducing the space complexity scaling to O(n), at least for overwriting multiplications. The second aspect reduces the actual number of multiplications that need be applied.

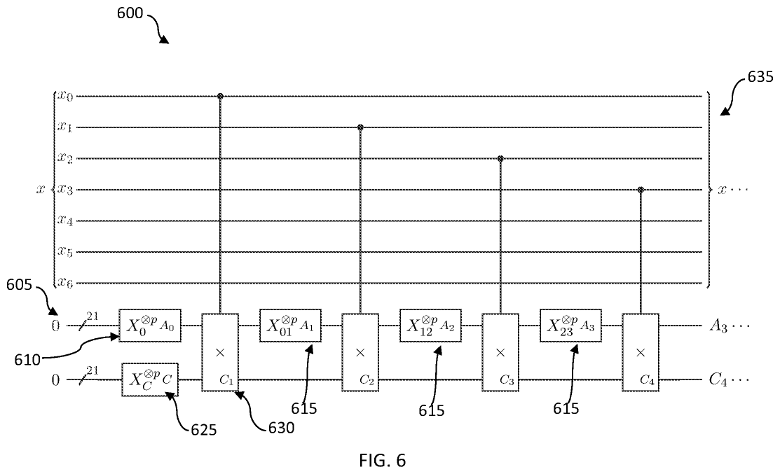

FIG. 6 illustrates part of a quantum circuit 600 for reducing space complexity in accordance with the disclosed embodiments. It should be appreciated that the quantum circuit 600 illustrated in FIG. 6 is used to implement refined quantum exponentiation, f(x′)=exp(−αx′). In the illustrated example, specific parameter values, d=7, n=21, and A=0.389 are used but other values can be used in other embodiments. Overwriting multiplications are presumed.

The parameters Aᵢ have constant values that can be determined prior to calculation. Rather than storing them in d separate registers, it is far less costly in terms of space to simply transform Aᵢ→Aᵢ₊₁, prior to each successive multiplication.

If overwriting multiplications are used, it then becomes necessary to maintain only two such n-qubit registers—i.e., register 605 to store all of the successive Aᵢ values, and register 610 to store the (conditionally superposed) Cᵢ values. The upper of the two 21-qubit registers 605 is used to store the Aᵢ, with the transformation gate 615 X^{⊗p} i(i+1) used to transform A into Aⁱ⁺¹. Similarly, we define transformation gates Xᵢ^{⊗p} to convert the zero state 0 into Aᵢ (or vice-versa). For example, the gate 610 X₀^{⊗p} is used at the start of the circuit to initialize A₀ from 0. Likewise, the lower 21-qubit register 610 is initialized to C from 0, using the transformation gate 625 X_{c}^{⊗p}. Each successive multiplication operation 630 (conditionally) multiplies this value by another factor of Aᵢ. In this manner, the total number of qubits is reduced to 2n+d, or 49 for the present example with QCC parameter values-again, not including the various ancilla bits (not indicated in FIG. 6) needed to effect the (overwriting) multiplications in practice.

This embodiment emphasizes minimal space complexity at the cost of greater gate depth. Alternatively, using all d Aᵢ registers as described herein, the multiplications could be performed synchronously and hierarchically, so as to minimize gate depth, but without any space reduction. In any event, the two exemplary QCC implementations discussed below are based on non-overwriting multiplications, for which the situation is a bit more complicated than in FIG. 6.

Another aspect of the disclosed embodiments is the implementation of the transformation gates. Since the transformations always correspond to fixed input and output values, they can be implemented as a set of very specific NOT gates, applied to just those qubits for which the binary expansions of equation 8 differ between input and output values. Hence the notation, ‘X^{⊗p}’, refers to the resultant tensor product of p≈n/2 NOT gates used to effect the transformation.

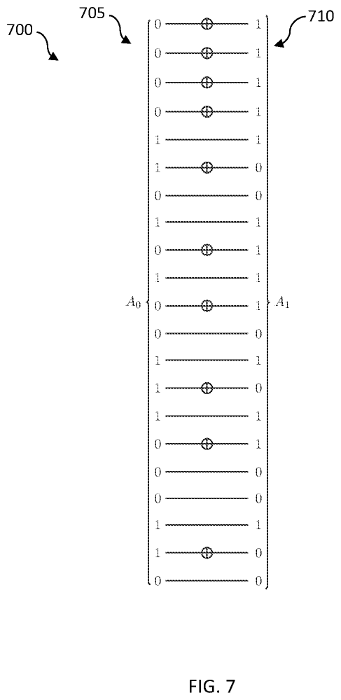

In FIG. 7, an implementation for the gate 700 X01^{⊗p} is presented, corresponding to the specific values, d=7, n=21, and A=0.389 (again for exemplary purposes only). The input qubits 705 are in an unsuperposed state corresponding to the n=21 binary expansion of A₀=A, as expressed in the form of Eq. (8) (with y₀ corresponding to the top wire, etc.) The output qubits 710 are in a similar state, but corresponding to A₁=A²=0.151321. Generally speaking, we may expect about half of the qubits to change their values. Indeed, for the present example with n=21, we find p=10. With the refined method and system presented in FIG. 6, there is one transformation required per multiplication. However, it is clear from FIG. 7 that the gate complexity of the former is trivial in comparison with that of the latter. In practical terms, therefore, the scheme of FIG. 6 can be implemented at almost no additional cost beyond that of FIG. 5, that is, the multiplication count can still be used as the measure of gate complexity.

Further embodiments disclosed herein are aimed at reducing gate complexity. In the initial discussion that follows, it is convenient to reconsider the d=n case. Note that for both the basic quantum method and system of FIG. 5, and the refined version of FIG. 6, a total of n multiplications are required—implying an overall gate complexity that scales asymptotically as O(n^{1+log}^{₂} ³)≈O(n^{2.585}) if Karatsuba multiplication is used. In reality, however, not all n of the multiplications need be applied in practice. In fact, it will be shown that the actual required number of multiplications, m, scales as log n (for fixed A)—thereby implying an asymptotic scaling of gate complexity no worse than O(n^{log}^{₂} ³ log n).

The important realization here is that equation (7) implies a very rapid reduction in Aᵢ with increasing i—essentially, as the exponential of an exponential. Consequently, there is no need to apply an explicit multiplication for any Aᵢ whose value is smaller than the smallest value that can be represented numerically in the fixed-point representation—i.e., 2⁻ⁿ, according to equation (8). What is needed, therefore, is an expression for m in terms of A and n, where m is the smallest i such that Aᵢ<2⁻ⁿ.

For the d=n case, the following equation 10 can be easily shown:

$$m = [ {log}_{2} ( \frac{n}{{log}_{2} \frac{1}{A}} ) ] + 1 \qquad ( 10 )$$

For the generic case where d and n are independent, more than d multiplications are never needed. So, equation (10) can be replaced with the general form, equation (11) as:

$$m = min \{ d , [ {log}_{2} ( \frac{n}{{log}_{2} \frac{1}{A}} ) ] + 1 \} \qquad ( 11 )$$

The number of multiplications m scales asymptotically as either O(d) or O(log n), rather than O(n), if A is fixed. This assumes, however, that d and A have no implicit dependence on n, which in turn depends on assumptions about how the x grid points are increased. If the xₘᵢₙ′≤x′<xₘₐₓ domain interval is expanded keeping the same spacing Δ, or if Δ decreases but d is kept constant, then the above holds. Otherwise, A→1 as n→∞, and the prefactor becomes divergently large, implying a less favorable asymptotic scaling law.

Consider the case where d<n. Since m(A) as described by equation (10) increases monotonically with A, there is, in general, an interval 0<A<Aₘₐₓ over which m(A)<d, and so a reduction in the number of multiplications can be realized and m<d. Beyond this point—i.e., for Aₘₐₓ≤A<1, all m=d basic multiplications must be used. The following expression for the transition A value is given as equation (12):

Aₘₐₓ=2⁻^{ⁿ}²^{^{d-1}} (12)

As an illustrative example, consider the exemplary values d=7, n=21, A=0.389. In this exemplary case, m=4 multiplications will be required, exactly as illustrated in FIG. 6. This represents a significant reduction versus the d=7 multiplications that would otherwise be needed. As confirmation that m=4 is correct, note that A₃=0.00052432, which is larger than 2⁻²¹=4.76810⁻⁷. However, A₄=2.74910⁻⁷<2⁻²¹.

Finally, Aₘₐₓ can be computed from equation (12), which, with the above n and d values, is Aₘₐₓ=0.796571. Thus, a reduction in m down from d, over about 80% of the range of possible A values is achieved. Now consider the Gaussian rather than exponential function, for which d→2d=14. Here, Aₘₐₓ=0.998225—which implies that there is almost always a reduction in m.

Although the refinement disclosed above, can lead to fewer than d multiplications (depending on the values of n, d, and A), this does not imply that the refined quantum method/system simply ends at the right edge circuit 600 of FIG. 6. There remains a subsequent computation that must occur, using the xᵢ≥m qubits, in order to ensure that the correct final value for the function is obtained. The multiplication count of the additional computation is zero, although it does add a cost of n Fredkin gates.

Consider that when x=2ⁱ is a power of two, then all but the xᵢ binary expansion coefficients in equation (5) vanish, and the function value simply becomes f(x)=CAᵢ, according to equation (6). This implies that for any x≥2^{m}, f(x)<2⁻ⁿ is smaller than the minimum non-zero number that can be represented, and so should be replaced with f(x)=0. This situation will occur if any of the (d−m) qubits, xᵢ≥m, are in their 1 states. Otherwise—i.e., if all (d−m) of the xᵢ≥m are in their 0 states so that x<2^{m} then nothing will happen, as the lowest register is already set to the correct output value, f(x)=Cₘ, at the right edge of circuit 600 in FIG. 6.

The above can be implemented as a series of steps. First, for the case A≥Aₘₐₓ, no additional circuitry is needed; the quantum circuit 600 of FIG. 6 can be implemented as is, except with explicit controlled multiplications across all m=d of the xᵢ qubits. For the case m=d−1, then d−1 controlled multiplications are implemented across the lowest d−1 qubits, x_{i<(d-1)}. The final qubit, x_{d-1} is then used to conditionally set the lowest register to zero.

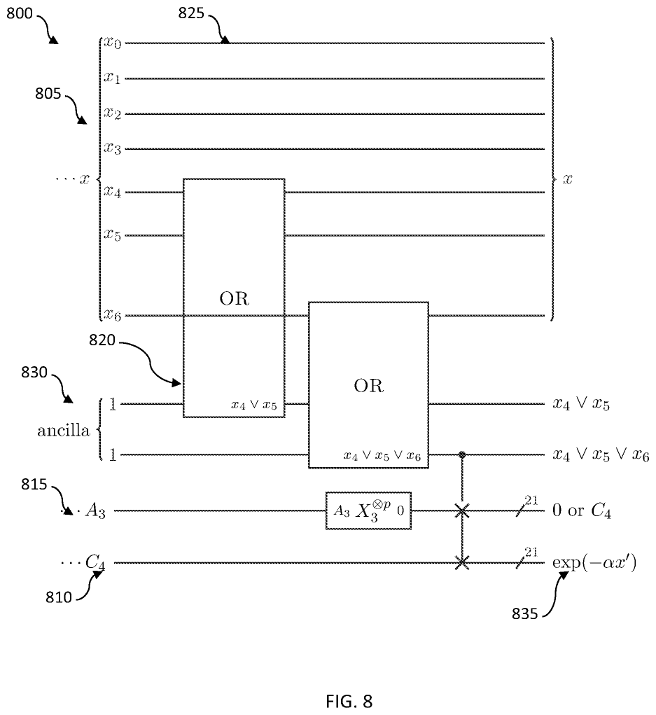

For the last case where (d−m)≥2, the quantum circuit illustrated in FIG. 8 can be employed. This requires first checking if any of the (d−m) xᵢ≥m qubits are in state 1, which is implemented using a sequence of (d−m−1) OR gates. The first is applied to xₘ and xₘ₊₁ to compute xₘvxₘ₊₁. If needed, that output is then sent to a second OR gate along with xₘ₊₂, etc. The final output, which will serve as a control qubit, has value 1 if any of the xᵢ≥m are in their 1 states; otherwise, it has value 0.

Meanwhile, the upper of the two n-qubit registers, which starts out representing the constant value Aₘ₋₁, is transformed to the value 0, using the transformation gate, X^{⊗p} m−1. Finally, the upper and lower n-qubit registers undergo a controlled SWAP^{⊗n}, applied in qubit-wise or tensor-product fashion, across all n qubits of the two registers. If the swap occurs, then the function output as represented by the lower of the two n-qubit registers becomes zero; otherwise, it is left alone.

Consideration of the reversible quantum OR gate, used in the quantum circuit 800 of FIG. 8 is also required. Quantum circuit 800 comprises the second half of a quantum circuit used to implement the refined quantum exponentiation, f(x′)=exp(−αx′), for exemplary parameter values, d=7, n=21, and A=0.389. The circuit generally comprises input qubit register 805, constant 815 A, and intermediate result 810 C. Multiple OR gates 820 are provided across wires 825 and ancilla qubits 830. The output wire 835 exp(−αx′) is constructed using the reversible quantum OR gate.

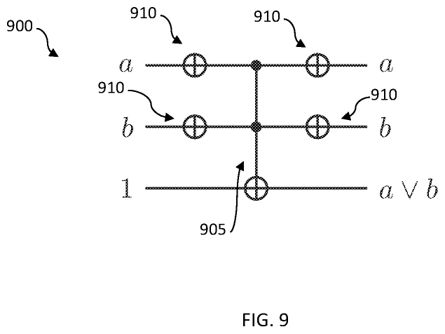

A reversible quantum OR gate 900 can be constructed from a single reversible NAND (Toffoli) gate 905, together with various NOT gates 910, as illustrated in FIG. 9, which shows a quantum circuit 900 used to implement a reversible OR gate. Note that each such OR gate 910 introduces one new ancilla qubit 830, initialized to the 1 state. There are thus no more than (d-m-1) additional ancilla qubits 830 in all that get introduced in this fashion. The additional costs associated with circuit 800, in terms of both gates and qubits, are thus both very small as compared to those of FIG. 6, although they are included in resource calculations going forward.

It is noteworthy that the disclosed embodiments rely on the “multiplication count” metric for gate complexity. Indeed, whereas current multiplication algorithms largely make use of integer or fixed-point arithmetic as considered here, floating-point algorithms-which have very different implementations—are also of interest going forward, especially for exponentiation. The multiplication count metric described here will continue to be relevant for all such innovations.

In certain embodiments, on the other hand, the two exemplary QCC implementations of the exponentiation circuit are used. In certain of those embodiments, a modified version of Ha\ddot{n}er's multiplication subroutine, which is itself a fixed-point version of “schoolbook” integer multiplication, based on bit shifts and controlled additions can be used. In particular, they exploit truncated additions (that maintain n fixed bits of precision), together with a highly efficient overwriting, controlled, ripple-carry addition circuit that minimizes both space and gate complexities. As it happens, there are some further improvements and simplifications that arise naturally for the disclosed exponentiation context, which can be exploited.

One characteristic of Ha\ddot{n}er multiplication is that it does not overwrite the multiplier input—the way, for example, that QFT multiplication would. Consequently, each successive multiplication requires additional ancilla bits, unlike what is presumed in FIG. 5. Space needs are accordingly greater in this implementation—becoming essentially mn+d qubits rather than 2n+d (without ancilla). For practical applications, m is still quite small, and so the increase is generally not too onerous. It is more of a concern for the Gaussian evaluations, for which m can in principle get twice as large as the corresponding exponential d value.

Of course, it would be possible to employ QFT-based multiplication in our exponentiation method—which would require 4n+d qubits, with ancilla included. On the other hand, the QFT approach is not Toffoli-based, and would therefore not lend itself to direct comparison with Ha\ddot{n}er, vis-à-vis gate complexity. In order to estimate a Toffoli count for QFT multiplication, one would have to presume some specific implementation for the Toffoli gate itself (e.g., in terms of T gates), which is not ideal. In any event, Toffoli counts have become a standard gate complexity metric in quantum computing.

For these reasons, overwriting QFT-based multiplications are not considered further here. Instead, for cases where the increased space complexity of the non-overwriting multipliers might pose a problem, the situation is addressed through the use of a simple alternative method (the second QCC implementation) that trades increased gate complexity for reduced space complexity—essentially by uncomputing intermediate results. In principle, there are any number of “reversible pebbling strategies” that might also be applied towards this purpose. The particular approach adopted herein, though, is quite effective.

Non-overwriting controlled quantum multiplication is disclosed herein as an aspect of the disclosed embodiments. As discussed, non-overwriting controlled-addition multiplication subroutines have three registers. The first is an input register for the multiplier; the second is another input register for the multiplicand; the third is the output or “accumulator” register. The accumulator register is initialized to zero, and therefore serves as an ancilla register, but comes to store the product of the multiplier and multiplicand at the end of the calculation.

For integer multiplication, the accumulator register requires 2n qubits, assuming that both input registers are n qubits each. The first register (multiplier) provides the control qubits for a cascade of n controlled additions. The second register (multiplicand) serves as the first input for each controlled addition. The second input for each controlled addition is a successively bit-shifted subset of n+1 qubits from the accumulator register. Note that overwriting controlled additions are used, so that for each controlled addition, the second register output is the sum of the two inputs.

In the case of the disclosed exponentiation methods and systems, a version of the above basic scheme can be used that is modified in two very important ways. First, the i'th multiplication is controlled, via the domain qubit xᵢ (as in FIG. 5). Second, the circuit exploits the fact that every multiplier has a fixed (unsuperposed) value—i.e., the constant, Aᵢ. Adding an overall control to a quantum circuit tends to complicate that circuit-turning CNOT gates into CC-NOT gates, etc. On the other hand, the fixed multiplier enables substantial simplifications—of the type used in Shor's algorithm for factoring integers, for instance.

Thus, we no longer treat the multiplier Aᵢ as an input register—for there is no longer a need to use the Aᵢ qubits as control bits for the additions. Instead, the binary expansion of Aᵢ from equation (8) is used to hard-wire what would be a set of uncontrolled additions, directly into the quantum circuit—but only for those binary expansion coefficients equal to 1. In addition to reducing the set of inputs by one entire n-bit register, this modification also reduces the number of additions that must be performed by a factor of two—since on average, only half of the expansion coefficients have the value 1.

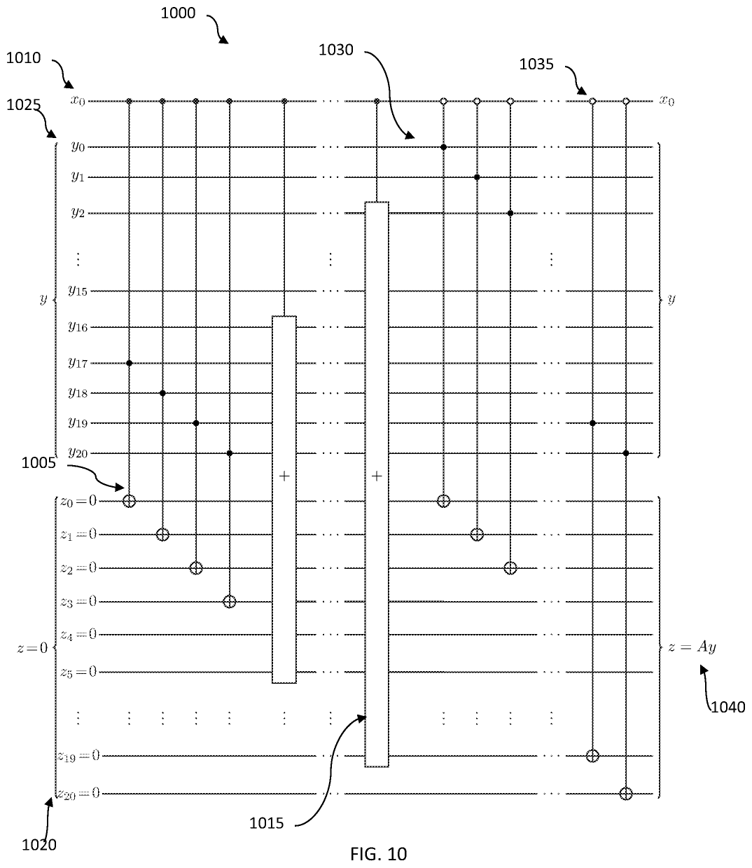

In addition to the above advantages, fixed-multiplier multiplication of circuit 1000 in FIG. 10 reduces circuit complexity by replacing controlled with uncontrolled additions—effectively converting CCNOT gates to CNOT gates 1005. Of course, when the xᵢ qubit control 1010 is thrown back in, to create the requisite controlled multiplication subroutine, the additions become controlled after all—but by xᵢ, rather than Aᵢ. In effect, the control bit for the multiplication is simply passed down to the individual controlled additions 1015 which comprise it.

This is illustrated in FIG. 10, which shows a quantum circuit 1000 for controlled multiplication, as implemented for the first multiplication in FIG. 5, denoted ‘×0’ (i.e., multiplication by A₀, controlled by the x₀ qubit). Note that the individual multiplication circuits, ×i, differ from each other, due to the different Aᵢ binary expansions. Once again, the canonical QCC parameter values are presumed for purposes of illustration, i.e., d=7, n=21, and A=0.389 in FIG. 10. In FIG. 10 each bit with value 1 is hard-wired into the quantum circuit 1000 as a distinct controlled addition, +1015. All operations are controlled by the single domain qubit 1010, x0.

From FIG. 10, another important difference from the basic scheme may be observed: the accumulator register, z 1020, has only n rather than 2n qubits. This is because fixed-point rather than integer arithmetic is being used—as a consequence of which, it is not necessary to store what would otherwise be the n least significant bits of the product. This situation provides yet another benefit, which is that each controlled addition becomes “truncated” to an s-bit operation—with s increasing with each successive controlled addition across the range, 2≤s≤(n−1).

Note that the smallest possible addition corresponds to s=2 rather than s=1. This is because the first controlled addition can be replaced with a cascade of Toffoli gates—or controlled bit-copy operations—which is a much more efficient implementation. This substitution works because the accumulator register z 1020 is set to zero initially. The very first controlled addition thus always (conditionally) adds the multiplicand register y 1025 to zero.

For the example as illustrated, the first four binary expansion coefficients for A (from right to left) are all zero; these bits are simply ignored. The first coefficient equal to one is the j=4 or fifth bit. As illustrated in FIG. 10, this causes the last four bits of the multiplicand register y 1025 to be (conditionally) copied into the first four bits of the accumulator register 1020—in what would otherwise be an s=4 controlled addition. The j=5 bit is also equal to one, leading to the first bona fide controlled addition in FIG. 10, with s=5. This pattern continues until the next-to-last, or j=19 bit is reached, which is the last bit equal to one. This leads to the final controlled addition, with s=19.

Although the last (j=20) bit is zero, even if it were equal to one, the corresponding controlled addition gate would extend only up to y₁. Thus, the top wire 1030, y₀, or least-significant bit of the multiplicand, is never used. This reflects the fact that both numbers being multiplied have values less than one, and that n fixed bits of precision are maintained throughout the calculation. Also note that, as a result, there are never any overflow errors.

The final part of the controlled multiplication circuit is a cascade of n controlled bit-copy operations (i.e., modified Toffoli gates 1035), which conditionally set the final output 1040 of the accumulator register 1020 equal to y, when x₀=0 (hence the open circles). Otherwise, this register would remain zero. Thus, the “do nothing” instruction, does not literally mean “do nothing” when non-overwriting multiplications are used, as it is still necessary to copy the multiplicand input register to the accumulator output register.

In further embodiments, Quantum space saving alternatives for exponentiation are disclosed. Now that the specific, controlled quantum multiplication method and associated circuit has been identified, a precise estimate of space requirements for the overall exponentiation circuit is possible. As noted, each of the m multiplications requires a clean n-qubit ancilla bundle as input for its accumulator register, together with the (accumulator) output from the most recent multiplication as input for its multiplicand register. Thus, for m successive multiplications, m+1 separate registers would be required in all.

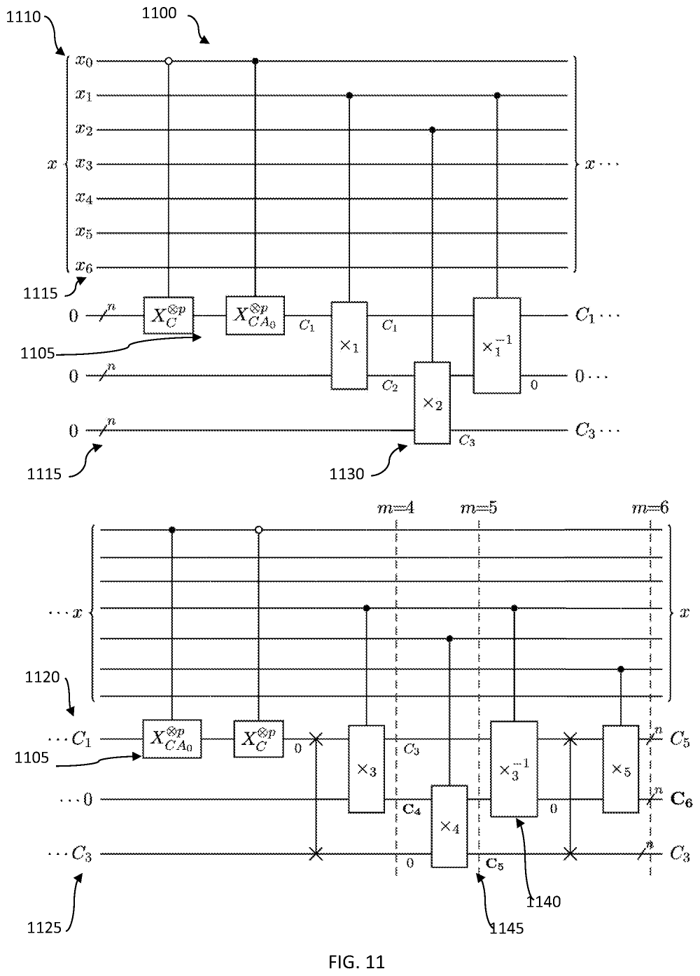

However, significant savings can be realized—i.e., one entire register of space, and one entire controlled multiplication subroutine—by exploiting the fact that the first multiplicand (i.e., C) is a fixed constant. The first controlled multiplication, ×0, is therefore a controlled multiplication of the constant C by the constant A₀. Since both constants are fixed, the controlled multiplication can be much more efficiently realized using two controlled transformation gates acting on a single register (i.e., the first two gates 1105 shown in circuit 1100 in FIG. 11) rather than the controlled multiplication circuit 1000 of FIG. 10. Note that this controlled ×0 implementation uses only CNOT gates; thus, the Toffoli count is zero.

Since Takahashi addition does not use additional ancilla qubits, the total number of qubits required to implement the m multiplications is just mn. In addition to this, we have the d qubits needed to store the domain register, x 1110, that is used to supply the control qubits 1115. The current qubit count is thus mn+d.

However, if m<d, then the second half of the refined exponentiation circuit (i.e., FIG. 8) must also be executed, which introduces some additional space overhead. To begin with, our current reliance on non-overwriting multiplications implies that we can no longer generate the requisite zero ancilla register (i.e., the next-to-last register in the figure) without significant (un)computation. To avoid this, we instead add a clean new register 1120—at the additional cost of n new qubits. In addition to this, there are the (d−m−1) ancilla bits used by the OR gates. Altogether then, the total qubit count becomes:

$$q = \{ \begin{matrix}dn + d & for m = d \\ ( m + 1 ) n + 2 d - m - 1 & for m < d\end{matrix} \qquad ( 13 )$$

To reduce qubit counts in cases where equation (13) renders a calculation unfeasible, the “space-saving” alternative implementation can be used. The basis of this embodiment is to uncompute some of the intermediate quantities, in order to restore some of the ancilla registers to their initial clean state, so that they can then be reused for subsequent computations. Of course, this requires additional overhead—i.e., in our case, additional controlled multiplications.

More specifically, the space-saving method reduces space requirements from O(mn) down to O(m^{1/2}n)—a very marked reduction, especially if m is reasonably large. The added cost in terms of gate complexity, on the other hand, is never more than double that of our original QCC implementation described above. Thus, m<mₛₛ<2m, with mₛₛ the multiplication count for the space-saving approach.

For values of m that lie in the range given by equation (14):

$$\frac{r ( r - 1 )}{2} < m \leq \frac{r ( r + 1 )}{2} \qquad ( 14 )$$

(Where r>2 is an integer), the space-saving method requires a total of r n-qubit registers to perform all multiplications. Note that the r>2 restriction implies that the method is only applicable for m>3. However, the m≤3 case presents minimal space requirements, and so the space-saving approach is less likely to be needed. In any event, for all numerical examples considered herein, (including the worst Gaussian cases), 3≤r≤5.

The total qubit count for the space-saving alternative algorithm can be shown to be given by equation (15) as follows:

$${q}_{s s} = \{ \begin{matrix}r n + d & for m = d \\ ( r + 1 ) n + 2 d - m - 1 & for m = \frac{r ( r + 1 )}{2} < d \\ r n + 2 d - m - 1 & otherwise\end{matrix} \qquad ( 15 )$$

Note that unlike the original non-space-saving or “gate-saving” method, a zero n-qubit ancilla register can always be made available for the final controlled SWAP^{⊗n} operation of FIG. 8, except when m=r(r+1)/2, which thus has an additional qubit cost.

The space-saving implementation can proceed as follows. First, apply the first r multiplications, exactly as for the earlier gate-saving approach. This leaves the r registers in the states, C₁, C₂, . . . , Cᵣ. Then, uncompute all but the most recent multiplication (i.e., the one that provided Cᵣ). The first (r−1) registers are thereby restored to zero, but the final register remains in the Cᵣ state. It is then possible to perform (r−1) additional multiplications, before once again running out of registers. All but the last of these is then uncomputed, allowing (r−2) more multiplications 1130 to be performed, and so on.

The space-saving quantum circuit 1100 used for d=7 and m=4-6 is presented in FIG. 11, corresponding to r=3 registers. For the first wave, there are three clean registers, allowing for three successive multiplications, ×0, ×1, and ×2 (provided ×0 is implemented as discussed above). This is followed by two uncompute multiplications for the first two multiplications, denoted ×₁⁻¹ and ×₀⁻¹ (the latter, again with the new implementation). In the second wave, apply ×3 and ×4, generating C₄ and C₅, respectively. This suffices for m=4 and m=5, respectively. However, if m=6, a third and final wave is necessary, as indicated in the figure.

As is clear from the above description, and from FIG. 11, the number of uncompute multiplications, mᵤₙ, is always less than m. Thus, mₛₛ=m+mᵤₙ<2m, as claimed. Precise values can be found as follows. Let I be the largest integer such that

$$\frac{l ( l + 1 )}{2} \leq \frac{r ( r + 1 )}{2 - m} \qquad ( 16 )$$

Then,

$${m}_{u n} = \frac{r ( r - 1 )}{2} - \frac{l ( l + 1 )}{2} \qquad ( 17 )$$

The following table indicates specific values for all m≤36. Note that the mₛₛ multiplication count includes both ×0 and ×0⁻¹; thus, the total actual number of controlled multiplication subroutines that must be executed is (mₛₛ−2), as indicated in the final column.

| m | r | mᵤₙ | (mₛₛ − 2) |
|---|---|---|---|
| 4 | 3 | 2 | 4 |
| 5 | 3 | 2 | 5 |
| 6 | 3 | 3 | 7 |
| 7 | 4 | 3 | 8 |
| 8 | 4 | 5 | 11 |
| 9 | 4 | 5 | 12 |
| 10 | 4 | 6 | 14 |
| 11 | 5 | 7 | 16 |
| 12 | 5 | 7 | 17 |
| 13 | 5 | 9 | 20 |
| 14 | 5 | 9 | 21 |
| 15 | 5 | 10 | 23 |
| 16 | 6 | 12 | 26 |
| 17 | 6 | 12 | 27 |
| 18 | 6 | 12 | 28 |
| 19 | 6 | 14 | 31 |
| 20 | 6 | 14 | 32 |
| 21 | 6 | 15 | 34 |
| 22 | 7 | 15 | 35 |
| 23 | 7 | 18 | 39 |
| 24 | 7 | 18 | 40 |
| 25 | 7 | 18 | 41 |
| 26 | 7 | 20 | 44 |
| 27 | 7 | 20 | 45 |
| 28 | 7 | 21 | 47 |
| 29 | 8 | 22 | 49 |
| 30 | 8 | 22 | 50 |
| 31 | 8 | 25 | 54 |
| 32 | 8 | 25 | 55 |
| 33 | 8 | 25 | 56 |
| 34 | 8 | 27 | 59 |
| 35 | 8 | 27 | 60 |
| 36 | 8 | 28 | 62 |

From the table, it can also be observed that greater space savings are usually associated with increased multiplication counts, and vice-versa.

It should be noted in accordance with the discussion above, that for m<d space saving calculations, a zero ancilla register is automatically available at the end of the FIG. 11 circuit (to be used in the subsequent FIG. 8 circuit), whenever equation (16) is a true inequality. When equation (16) is an equality, then the I=0 case requires the addition of a new zero ancilla register (as discussed), but for I>0, a zero register can be easily created from an existing non-zero register. This is done by applying the single uncompute multiplication, ×⁻¹. As an example, m−2 the case m=5 corresponds to I=1 and r=3, thus satisfying equation (16) as an equality, with both sides equal to one. The necessary uncompute multiplication 1140 can be seen in circuit 1100 of FIG. 11, just to the right of the vertical dashed line 1145 marked ‘m=5’. Note that the Toffoli count associated with such i m multiplications is greatly reduced in comparison with the other multiplications. This event is fairly rarely realized in practice, including the examples given herein.

The methods and systems disclosed herein allow the exponential function to be evaluated on quantum computers for the cost of a few multiplications. This basic functionality will continue to hold true, regardless of the many quantum hardware and software innovations that will come on the scene in ensuing decades.

While there are a plethora of multiplication algorithms available, both overwriting (e.g. QFT-based) and non-overwriting (e.g. controlled addition), and for both integer and fixed-point arithmetic, as well as new strategies for floating-point arithmetic, quantum error correction, etc., the disclosed embodiments provide implementation-independent “multiplication count” as the most sensible gate complexity metric, for any quantum algorithm whose dominant cost can be expressed in terms of multiplications. The present methods are certainly of this type.

According to the disclosed exponentiation strategy, the (controlled) multiplication count m will indeed be rather small in practice—at least for the applications envisioned. To begin with, in a great many simulation contexts, the domain resolution as expressed in total qubits d, is far less than the range resolution n—with m≤d. For QCC, for instance, the exemplary d=7 and d=8 values considered herein are likely to suffice in practice. Conversely, the asymptotically large n=d limit, in which it can be shown (in Eq. (10)) that m=O(log n) for fixed A. In this limit, Karatsuba multiplication provides better asymptotic scaling. Using the Gidney implementation, the Toffoli and qubit counts for exponentiation scale as O(n^{log}^{₂} ³m) and O(nm), respectively.

The embodiments disclosed herein include two specific implementations of the general exponentiation methods and systems, suitable for QCC calculations but also more broadly, e.g. for quantum finance. When compared with certain prior art methods the disclosed implementations are found to reduce Toffoli counts by an order of magnitude or more. Qubit counts are also (generally) substantially reduced. Note that the disclosed embodiments are complementary, with one designed to favor gate and the other space resource needs. Together, they provide the flexibility needed to actually implement exponentiation on quantum computing architectures.

Finally, the present exponentiation methods and systems can be applied within the context in which they were originally conceived—i.e., quantum computational chemistry (QCC). The long-awaited QCC revolution may be nearly upon us, although achieving full quantum supremacy will likely require quantum platforms that can accommodate first-quantized methods. On classical computers, the Cartesian-component separated approach, as developed offers a highly competitive first-quantized strategy.

On quantum computers, the question appears to boil down to the relative costs of the exponential function vs. the inverse square root. Note that the larger-domain-interval calculations—i.e., those with lower Toffoli counts—are the more realistic in this context. This is because the QCC CCS implementation requires multiple exponentiations with different a values to be performed, across the same grid domain interval—which must accordingly be large enough to accommodate all of them. The disclosed exponentiation cost as compared to the cost of the inverse-square-root function, as applied using prior art methods, offers significant improvement.

The embodiments disclosed herein can aid in the pursuit of an important goal, namely, achieving “quantum advantage,” or useful calculations performed on a quantum computer that cannot be performed on classical computers without an inordinate amount of time or computational resources. This requires: (a) validation of the accuracy level (i.e. error bars) of quantum results; and (b) the ability to perform a similar calculation on a classical computer.

The disclosed embodiment can aid in the field of “quantum benchmarking”, offering reliably accurate benchmark data for extremely challenging computational applications of interest using quantum computing hardware and software. For example, the disclosed embodiments can be used to perform calculations whose scope far exceeds that of conventional classical methods.

Such calculations will benefit quantum computing both in the drive towards quantum advantage, and to reliably and accurately benchmark data in order to validate the accuracy of results. Second, the disclosed systems and methods can also be used to help provide accurate resource estimates for quantum calculations.

The disclosed embodiments can be applied to many different types of applications of current interest in quantum computing, including but not limited to: first- and second-quantized electronic structure; spin models and problems of various kinds; quantum dynamics; optimization; cryptography (factorization), and quantum finance.

The disclosed embodiments thus establish a new paradigm of information representation and processing that can ultimately provide better methods and algorithms for quantum computers.

Furthermore, the disclosed embodiments can be used to provide benchmarking services, with methods sufficiently accurate and reliable to be applied in other domains such as drug discovery and materials. Other fields where the current methods and system can be applied include 1) second-quantized quantum chemistry; 2) spin models; 3) periodic boundary conditions; 4) optimization; 5) factorization, etc.

In the long term, once quantum error correction becomes viable and fault-tolerant quantum computing is widespread, aspects of the embodiments can be used to push the limits of what can be done on quantum computers, particularly in the realm of quantum chemistry and quantum finance.

Based on the foregoing, it can be appreciated that a number of embodiments, preferred and alternative, are disclosed herein. In an embodiment a system comprises a quantum circuit, the quantum circuit comprising: a plurality of an integer number of d control qubits, an output register configured to store a current function value, at least one multiplication block, and an input register comprising a plurality of input qubits wherein successive multiplications are performed, according to the at least one multiplication block, between the current function value and successive constants stored in the input register, in order to evaluate a function. In an embodiment, the output register further comprises: a plurality of an integer number n of qubits configured to store the current function value. In an embodiment, the function comprises an exponential function.

In an embodiment, the plurality of control qubits serve as control for the multiplication at the multiplication block. In an embodiment, each successive constant is stored in an integer n number of input qubits in the input register. In an embodiment, the at least one multiplication block comprises an integer number of d multiplication blocks.

In an embodiment, the system further comprises at least one transformation gate configured to transform each of the successive constants into the next successive constant before the next multiplication block. In an embodiment the system further comprises a current function value transformation gate used to initialize the current function value. In an embodiment a parameter value transformation gate is used to initialize a current parameter value.

In an embodiment, the system further comprises a quantum computer, an input module for entering function parameters, quantum storage, and an output module for outputting the evaluated function.

In another embodiment a method for quantum exponentiation, comprises representing the value of a function with a plurality of qubits, initially assigning an output register a constant value, storing a plurality of parameter values in a plurality of n qubits, multiplying the initially assigned constant value with a first of the plurality of parameter values to reach an intermediate exponential value, iterating the multiplication for each of the exponent values with the adjusted constant parameter value, and storing the final value in an output register representing the value of the exponential function.

In an embodiment the method for quantum exponentiation further comprises controlling the multiplication with a control qubit.

In an embodiment, the method for quantum exponentiation the function comprises one of: an exponential function or a Gaussian function. In an embodiment, the method for quantum exponentiation further comprises defining a domain with a domain interval as xₘᵢₙ′≤x′≤xₘₐₓ′. In an embodiment the domain is represented with a plurality of d qubits.

In an embodiment, of the method for quantum exponentiation the multiplication for each of the exponent values is overwritten on an additional input register with a product of the multiplication of the exponent value and adjusted constant value.

In another embodiment, a non-overwriting quantum circuit comprises a first input register for storing a multiplier, a second input register for storing a multiplicand, an accumulator register, a plurality of cascading controlled addition blocks for summing inputs provided by the second input register and successively bit-shifted subsets of qubits from the accumulator register, a plurality of CNOT gates, and a domain qubit.

In an embodiment, the accumulator register is initialized to zero and the accumulator register stores the product of the multiplier and multiplicand.

In an embodiment, of the non-overwriting quantum circuit the controlled addition blocks use fixed-point arithmetic.

In an embodiment, the non-overwriting quantum circuit of claim 16 further comprises a cascade of controlled bit-copy operations configured to set a final output of the accumulator register.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A system comprising:
a quantum circuit, the quantum circuit comprising:
a plurality of an integer number of d control qubits;
an output register configured to store a current function value;
at least one multiplication block; and
an input register comprising a plurality of input qubits wherein successive multiplications are performed, according to the at least one multiplication block, between the current function value and successive constants stored in the input register, in order to evaluate a function.

2. The system of claim 1 wherein the output register further comprises:
a plurality of an integer number n of qubits configured to store the current function value.

3. The system of claim 1 wherein the function comprises one of:
an exponential function; and
a Gaussian function.

4. The system of claim 1 wherein the plurality of integer number of d control qubits serve as control for the multiplication at the at least one multiplication block.

5. The system of claim 1 wherein each of the successive constants is stored in an integer n number of input qubits in the input register.

6. The system of claim 1 wherein the at least one multiplication block comprises an integer number of d multiplication blocks.

7. The system of claim 6 further comprising:
at least one transformation gate configured to transform each of the successive constants into the next successive constant before a next multiplication block of the d multiplication blocks.

8. The system of claim 7 further comprising:
a parameter value transformation gate used to initialize a current parameter value.

9. The system of claim 1 further comprising:
a quantum computer;
an input module for entering function parameters;
quantum storage; and
an output module for outputting the evaluated function.

10. A method for quantum exponentiation, comprising:
representing the value of a function with a plurality of qubits;
initially assigning an output register a constant value;
storing a plurality of parameter values in a plurality of n qubits;
multiplying the initially assigned constant value with a first of the plurality of parameter values to reach an intermediate exponential value;
iterating the multiplication for each of the exponent values with the adjusted constant parameter value; and
storing a final value in an output register representing the value of the function.

11. The method for quantum exponentiation of claim 10 further comprising:
controlling the multiplication with a control qubit.

12. The method for quantum exponentiation of claim 10 wherein the function comprises one of:
an exponential function; or
a Gaussian function.

13. The method for quantum exponentiation of claim 10 further comprising:
defining a domain with a domain interval as xₘᵢₙ′≤x′≤xₘₐₓ′.

14. The method for quantum exponentiation of claim 13 wherein the domain is represented with a plurality of d qubits.

15. The method for quantum exponentiation of claim 10 wherein the multiplication for each of the exponent values is overwritten on an additional input register with a product of the multiplication of the exponent value and adjusted constant value.

16. A non-overwriting quantum circuit comprising:
a first input register for storing a multiplier;
a second input register for storing a multiplicand;
an accumulator register;
a plurality of cascading controlled addition blocks for summing inputs provided by the second input register and successively bit-shifted subsets of qubits from the accumulator register;
a plurality of CNOT gates; and
a domain qubit.

17. The non-overwriting quantum circuit of claim 16 wherein the accumulator register is initialized to zero.

18. The non-overwriting quantum circuit of claim 16 wherein the accumulator register stores a product of the multiplier and multiplicand.

19. The non-overwriting quantum circuit of claim 16 wherein the controlled addition blocks use fixed-point arithmetic.

20. The non-overwriting quantum circuit of claim 16 further comprising:
a cascade of controlled bit-copy operations configured to set a final output of the accumulator register.
